(19) United States
(12) Patent Application Publication
(10) Pub. No.: US 2016/0147218 A1
(43) Pub. Date: May 26, 2016

(54) COMPUTING DEVICE AND METHOD FOR OUTPUTTING PROGRAMS OF A WORKPIECE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); ZONG-TAO YANG, Shenzhen (CN)

(21) Appl. No.: 14/688,607

(22) Filed: Apr. 16, 2015

(30) Foreign Application Priority Data
Nov. 24, 2014 (CN) 201410678719.0

(51) Int. Cl. G05B 19/4099

(52) U.S. Cl. CPC G05B 19/4099; G05B 2219/35134

(57) ABSTRACT

In a method for outputting programs of a workpiece placed on a scanner device using a computing device, three-dimensional (3D) point cloud data of the workpiece is received from the scanner device. The received 3D point cloud data is meshed into a plurality of triangles, and a 3D model of the workpiece is obtained. A measurement point on the 3D model selected, and coordinates of the measurement point on the 3D model is calculated. A measurement element is created according to the calculated coordinates. A preset virtual probe is imported to be displayed on a display screen, and the virtual probe is rotated according to a normal vector of the created measurement element. The method controls the virtual probe to move towards the created measurement element, and outputs programs of the created measurement element.

### CROSS-REFERENCE TO RELATED APPLICATIONS

This application claims priority to Chinese Patent Application No. 201410678719.0 filed on Nov. 24, 2014, the contents of which are incorporated by reference herein.

### FIELD

Embodiments of the present disclosure relate to programming technology, and particularly to a computing device and a method for outputting programs of a workpiece using the computing device.

### BACKGROUND

When a programming system compiles programs of a product (for example, a workpiece), a three-dimensional (3D) drawing (for example, a Computer Aided Design (CAD) drawing) of the product needs to be imported into a computing device to help the programming system compile the programs. If the product does not have a 3D drawing or there are differences between the 3D drawing and the product, measurement parameters perimeters of the product can be inaccurate.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of a computing device including a program outputting system.

FIG. 2 is a block diagram of one embodiment of the program outputting system in the computing device of FIG. 1.

FIG. 3 is a flowchart of one embodiment of a method of outputting programs of a workpiece using the computing device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.” It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In the present disclosure, “module,” refers to logic embodied in hardware or firmware, or to a collection of software instructions, written in a program language. In at least one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives. The term “comprising” means “including, but not necessarily limited to”; it specifically indicates open-ended inclusion or membership in a so-described combination, group, series and the like.

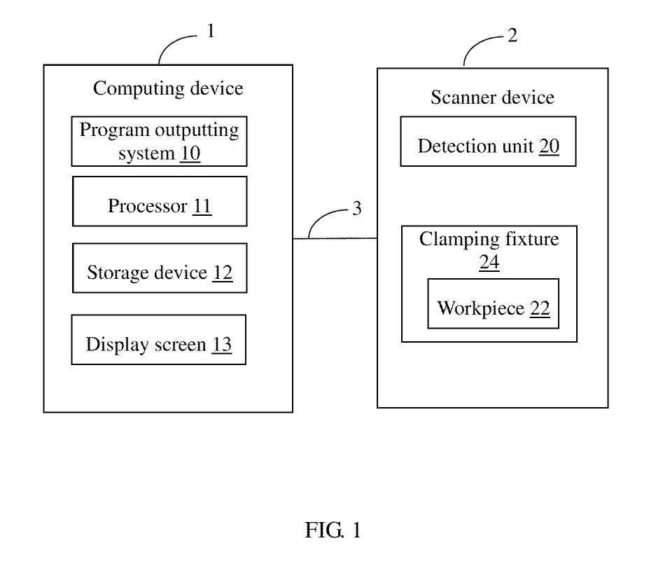

FIG. 1 is a block diagram of one embodiment of a computing device including a program outputting system. The computing device 1 can include, but is not limited to, a program outputting system 10, at least one processor 11, a storage device 12, and a display screen 13. The at least one processor 11 executes one or more computerized codes and other applications of the computing device 1 to provide functions of the program outputting system 10. The storage device 12 can be an internal storage device, such as a random access memory (RAM) for temporary storage of information, and/or a read only memory (ROM) for permanent storage of information. The storage device 12 can also be an external storage device, such as an external hard disk, a storage card, or a data storage medium.

In at least one embodiment, the computing device 1 is connected to a scanner device 2 through a data cable 3. The scanner device 2 can be a three-dimensional (3D) scanner. The scanner device 2 includes, but is not limited to, a detection unit 20 and a clamping fixture 24. A workpiece 22 can be placed on the clamping fixture 24. The scanner device 2 can use the detection unit 20 to scan a whole surface of the workpiece 22 on the clamping fixture 24, generate and output three dimensional (3D) point cloud data of the workpiece 22 to the computing device 1. The detection unit 20 can be a binocular Charge-coupled Device (CCD). The 3D point cloud data includes coordinates values (e.g., X, Y, and Z coordinate values) of a plurality of points of the workpiece 22.

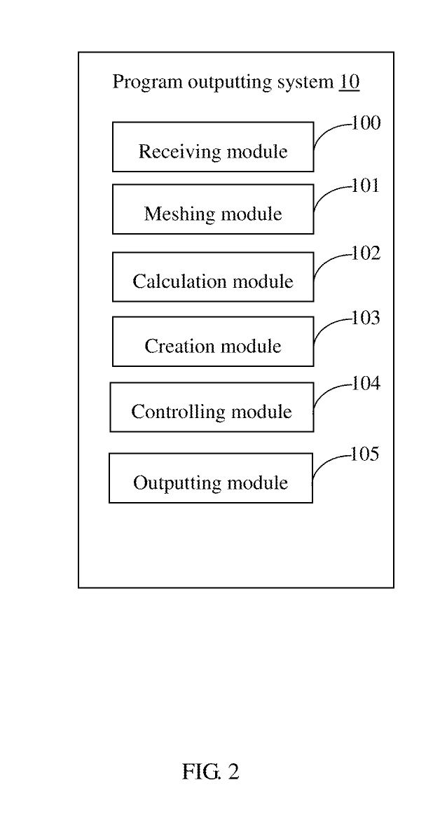

FIG. 2 is a block diagram of one embodiment of the program outputting system of the computing device of FIG. 1. In this embodiment, the program outputting system 10 includes, but is not limited to, a receiving module 100, a meshing module 101, a calculation module 102, a creation module 103, a controlling module 104, and an outputting module 105. The modules 100-105 include computerized code in the form of one or more programs that are stored in the storage device 12. The computerized code includes instructions that are executed by the at least one processor 11 to provide functions of the program outputting system 10.

The receiving module 100 can receive 3D point cloud data of the workpiece 22 from the scanner device 2.

The meshing module 101 can mesh the received 3D point cloud data into a plurality of triangles, and obtaining a 3D model of the workpiece 22 by simplifying the triangles. In at least one embodiment, the meshing module 101 can mesh point cloud data based on at least one preset rule. The at least one preset rule can include a first rule representing that no point in the point cloud data is inside circumscribed circles of the triangles, and a second rule representing that curvatures of neighboring triangles are similar to each other. When a triangle is formed based on the first rule, the triangle can be examined based on the second rule. An angle between a vector of the triangle and a vector of each neighboring triangle can be computed. If there is an angle between the vector of the triangle and the vector of the neighboring triangle greater than a preset curvature threshold (for example, 90°), the triangle is discarded and reconstructed with other points to generate a new triangle.

For example, the meshing module 101 selects a point in the point cloud data as a first point of a triangle, and further selects a point near the first point as a second point. In at least one embodiment, a threshold of a distance between the first point and the second point can be preset or modified by a user. In at least one embodiment, the meshing module can select the nearest point for the first point. The meshing module 101 connects the first point and the second point, and determines a third point of the triangle. When the meshing module 101 selects the third point, the meshing module 101 prevents other points in the point cloud from being inside the circumscribed circle of the triangle formed by the first point, the second point and the third point.

In at least one embodiment, the plurality of triangles meshed from the received 3D point cloud data can be simplified according to a preset method. For example, the preset method includes deducting a preset percentage (for example, 30%) of the triangles whose curvatures are within a preset range (for example, a range from 0° to 10°).

The calculation module 102 can calculate safe surfaces on three axis of the 3D model. In at least one embodiment, the calculation module 102 determines a maximum bounding box of the 3D model by calculating a minimum X coordinate value and a maximum X coordinate value, a minimum Y coordinate value and a maximum Y coordinate value, and a minimum Z coordinate value and a maximum Z coordinate value, from all coordinates values of the 3D model. The calculation module 102 further determines the safe surfaces based on the maximum bounding box and a preset threshold value. Each point on the safe surfaces is greater than a corresponding point on the maximum bounding box for one preset threshold value.

The calculation module 102 can further select a measurement point on the 3D model, and calculate coordinates of the measurement point on the 3D model. In at least one embodiment, the user can select the measurement point by clicking one point on the 3D model using a mouse (not shown in FIGs), or by inputting coordinates of one point on the 3D model. The calculation module 102 can generate a ray passing through the measurement point along a normal line of the display screen 13, obtain an intersection line between the ray and the 3D model, and determine initial coordinates of the measurement point based on the intersection line.

In at least one embodiment, the calculation module 102 determines a plurality of neighboring triangles adjacent to the generated ray. The 3D model can be divided into a plurality of small boxes based on a bounding box algorithm. Each of the small boxes can be assigned a number so that the plurality of neighboring triangles adjacent to the generated ray can be easily obtained based on the assigned numbers. There are many intersection points between the 3D model because the normal line has a forward direction and a backward direction. The calculation module 102 obtains an intersection line between the generated ray and the 3D model based on the intersection points. In addition, a ray is externally generated from a point on a surface of the workpiece 22, which intersects with the workpiece 22 only at the point on the surface of the workpiece 22. Therefore, the calculation module 102 can obtain an external vertex of the intersection line at which the ray intersects with the surface of the 3D model. Coordinates of the external vertex are determined to be the coordinates of the measurement point.

The creation module 103 can create a measurement element according to the calculated coordinates of the measurement point and a selected element type. The measurement element may include lines, planes, and circles according to element types of “line”, “plane” and “circle”. In at least one embodiment, the creation module 103 can fit the measurement element based on the calculated coordinates of the measurement point and triangles adjacent to the measurement point according to a least-square method and a Quasi-Newton iterative method. In other embodiments, the creation module 103 can further create two or more measurement elements according to two or more selected element types.

The controlling module 104 can display a preset virtual probe on the display screen 13, and rotate the virtual probe according to a normal vector of the created measurement element. The virtual probe is a model of an actual probe of a measurement machine.

The controlling module 104 can further control the virtual probe to move towards the created a measurement element based on the calculated safe surfaces. The virtual probe does not collide with the 3D model of the workpiece 22 because the virtual probe is moved based on the safe surfaces, that is, the virtual probe has no intersection with the 3D model. In other embodiments, if there are two or more measurement elements created by the creation module 103, the controlling module 104 controls the virtual probe according to a normal vector of one of the measurement elements and controls the virtual probe to move towards one of the measurement elements in sequence.

The outputting module 105 can output programs of the created measurement element including feature information of the created measurement element and a movement path of the virtual probe. In at least one embodiment, the measurement element can be characterized by the feature information. For example, if the measurement element is a line, the feature information may include coordinates of a start point and an end point of the line. If the measurement element is a plane, the feature information may include coordinates of a center point and a normal vector of the plane. If the measurement element is a circle, the feature information may include coordinates of a center point, a radius, and a normal vector of the circle. The movement path is determined according to the movement of the virtual probe.

After obtaining the programs of all of measurement elements of the 3D model of the workpiece 22, the outputting module 105 obtains an integrated program by integrating the obtained programs.

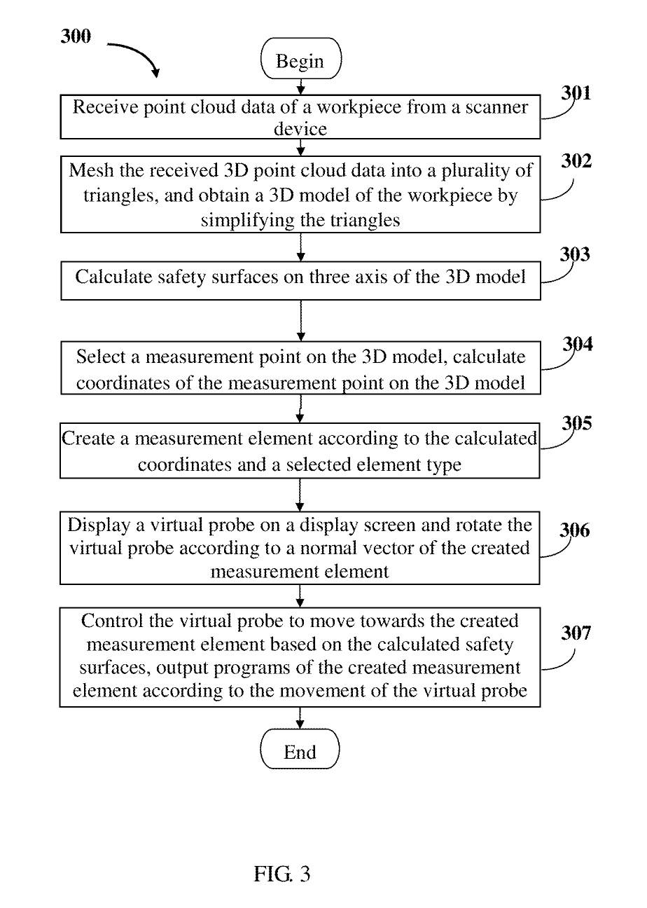

FIG. 3 is a flowchart of one embodiment of a method of outputting programs of a workpiece using the computing device in FIG. 1. Depending on the embodiment, additional blocks can be added, others removed, and the ordering of the blocks can be changed. In the embodiment, the method 300 is performed by execution of computer-readable software program codes or instructions by at least one processor of a computing device. The method 300 is provided by way of example, as there are a variety of ways to carry out the method. The method 300 described below can be carried out using the configurations illustrated in FIGS. 1-2, for example, and various elements of these figures are referenced in explaining method 300. Each block shown in FIG. 3 represents one or more processes, methods or subroutines, carried out in the method 300. Furthermore, the illustrated order of blocks is by example only and the order of the blocks can change according to the present disclosure. Additional blocks may be added or fewer blocks may be utilized, without departing from this disclosure. The example method 300 can begin at block 301.

At block 301, a receiving module receives 3D point cloud data of the workpiece 22 from the scanner device 2.

At block 302, a meshing module meshes the received 3D point cloud data into a plurality of triangles, and obtains a 3D model of the workpiece 22 by simplify the triangles. In at least one embodiment, the meshing module meshes point cloud data based on at least one preset rule. The at least one preset rule includes a first rule that no point in the point cloud is inside the circumscribed circles of the triangles, and a second rule that curvatures of neighboring triangles are similar to each other. When a triangle is formed based on the first rule, the triangle can be examined based on the second rule. An angle between a vector of the triangle and a vector of each neighboring triangle of the triangle can be computed. If there is an angle between the vector of the triangle and the vector of the neighboring triangle greater than a preset curvature threshold (for example, 90°), the triangle will be discarded and reconstructed with other points to generate a new triangle. For example, the meshing module selects a point in the point cloud data as a first point of a triangle, and further selects a point near the first point as a second point. In at least one embodiment, a threshold of a distance between the first point and the second point can be preset by a user. In at least one embodiment, the meshing module can select the nearest point for the first point. The meshing module connects the first point and the second point, and determines a third point of the triangle that there is no point in a circumcircle of the triangle which is consisting of the first point, the second point and the third point.

In at least one embodiment, the plurality of triangles meshed from the received 3D point cloud data can be simplified accord to a preset method. For example, the preset method is described as: deducting a preset percentage (for example, 30%) of the triangles whose curvatures are within a preset range (for example, a range from 0° to 10°).

At block 303, a calculation module calculates safe surfaces on three axis of the 3D model. In at least one embodiment, the calculation module calculates a minimum value and a maximum value of X coordinate values, a minimum value and a maximum value of Y coordinate values, and a minimum value and a maximum value of Z coordinate values, from all coordinates values of the 3D model for determining a maximum bounding box of the 3D model. The calculation module further determines the safe surfaces based on the maximum bounding box and a preset threshold value. Each point on the safe surfaces is greater than the corresponding point on the maximum bounding box for one preset threshold value.

At block 304, the calculation module further selects a measurement point on the 3D model, and calculates coordinates of the measurement point on the 3D model. In at least one embodiment, the user can select the measurement point by clicking one point on the 3D model using a mouse (not shown in FIGs), or by inputting coordinates of one point. The calculation module generates a ray passing through the measurement point along a normal line of the display screen 13, obtains an intersection line between the ray and the 3D model, and then determines initial coordinates of the measurement point based on the intersection line.

At block 305, a creation module creates a measurement element according to the calculated coordinates of the measurement point and a selected element type. The measurement element may include lines, planes, and circles according to the element types of “line”, “plane” and “circle”. In at least one embodiment, the creation module can fit the measurement element based on the calculated coordinates of the measurement point and triangles adjacent to the measurement point according to a least-square method and a Quasi-Newton iterative method.

At block 306, a controlling module displays a preset virtual probe on the display screen 13, and rotates the virtual probe according to a normal vector of the created measurement element. The virtual probe is a model of an actual probe of a measurement machine.

At block 307, the controlling module further controls the virtual probe to move towards the created measurement element based on the calculated safe surfaces, and an outputting module outputs programs of the created measurement element including feature information of the created measurement element and a path of the movement of the virtual probe. In at least one embodiment, the measurement element can be characterized by the feature information. For example, if the measurement element is a line, the feature information may include coordinates of a start point and an end point of the line. If the measurement element is a plane, the feature information may include coordinates of a center point and a normal vector of the plane. If the measurement element is a circle, the feature information may include coordinates of a center point, a radius, and a normal vector of the circle.

All of the processes described above can be embodied in, and fully automated via, functional code modules executed by one or more general purpose processors such as the processor 11. The code modules can be stored in any type of non-transitory readable medium or other storage device such as the storage device 12. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-implemented method for outputting programs of a workpiece using a computing device, the method being executed by at least one processor of the computing device, comprising:
receiving, from a scanner device, three-dimensional (3D) point cloud data of the workpiece;
meshing the received 3D point cloud data into a plurality of triangles;
obtaining a 3D model of the workpiece;
selecting a measurement point on the 3D model and calculating coordinates of the measurement point on the 3D model;
creating a measurement element according to the calculated coordinates of the measurement point and a preselected element type;
displaying a preset virtual probe on a display screen of the computing device, and rotating the preset virtual probe according to a normal vector of the created measurement element;
controlling the preset virtual probe to move towards the created measurement element; and
providing an output of the created measurement element, the output comprising feature information of the created measurement element and a movement path of the preset virtual probe.

2. The method according to claim 1, further comprising:
calculating safe surfaces on three axis of the 3D model.

3. The method according to claim 2, wherein the safe surfaces on three axis of the 3D model are calculated by:
calculating a maximum bounding box of the 3D model; and
determining the safe surfaces based on the maximum bounding box and a preset threshold value, and each point on the safe surfaces being greater than corresponding point on the maximum bounding box for the preset threshold value.

4. The method according to claim 2, wherein the preset virtual probe is controlled to be moved based on the safe surfaces.

5. The method according to claim 1, wherein the measurement element is created by:
fitting the measurement element based on the calculated coordinates of the measurement point and triangles adjacent to the measurement point according to a least-square method and a Quasi-Newton iterative method.

6. A non-transitory computer-readable storage medium storing a set of instructions, when executed by at least one processor of a computing device, cause the at least one processor to perform a method for outputting programs of a workpiece placed on a scanner device, the method comprising:
receiving, from a scanner device, three-dimensional (3D) point cloud data of the workpiece;
meshing the received 3D point cloud data into a plurality of triangles;
obtaining a 3D model of the workpiece;
selecting a measurement point on the 3D model and calculating coordinates of the measurement point on the 3D model;
creating a measurement element according to the calculated coordinates of the measurement point and a preselected element type;
displaying a preset virtual probe on a display screen of the computing device, and rotating the preset virtual probe according to a normal vector of the created measurement element;
controlling the preset virtual probe to move towards the created measurement element; and
providing an output of the created measurement element, the output comprising feature information of the created measurement element and a movement path of the preset virtual probe.

7. The storage medium according to claim 6, wherein the method further comprises:
calculating safe surfaces on three axis of the 3D model.

8. The storage medium according to claim 7, wherein the safe surfaces on three axis of the 3D model is calculated by:
calculating a maximum bounding box of the 3D model; and
determining the safe surfaces based on the maximum bounding box and a preset threshold value, and each point on the safe surfaces being greater than the corresponding point on the maximum bounding box for the preset threshold value.

9. The storage medium according to claim 7, wherein the preset virtual probe is controlled to be moved based on the safe surfaces.

10. The storage medium according to claim 6, wherein the measurement element is created by:
fitting the measurement element based on the calculated coordinates of the measurement point and triangles adjacent to the measurement point according to a least-square method and a Quasi-Newton iterative method.

11. A computing device being connected to a scanner device, the computing device comprising:
at least one processor; and
a storage device storing one or more programs, which are executed by the at least one processor, cause the at least one processor to:
receive three-dimensional (3D) point cloud data of the workpiece from the scanner device;
mesh the received 3D point cloud data into a plurality of triangles, and obtaining a 3D model of the workpiece;
select a measurement point on the 3D model, and calculating coordinates of the measurement point on the 3D model;
create a measurement element according to the calculated coordinates of the measurement point and a preselected element type;
display a preset virtual probe on a display screen of the computing device, and rotating the preset virtual probe according to a normal vector of the created measurement element;
control the preset virtual probe to move towards the created measurement element; and
output programs of the created measurement element comprising feature information of the created measurement element and a movement path of the preset virtual probe.

12. The computing device according to claim 11, wherein the at least one processor further:
calculate safe surfaces on three axis of the 3D model.

13. The computing device according to claim 12, wherein the safe surfaces on three axis of the 3D model is calculated by:
calculating a maximum bounding box of the 3D model; and
determining the safe surfaces based on the maximum bounding box and a preset threshold value, and each point on the safe surfaces being greater than the corresponding point on the maximum bounding box for the preset threshold value.

14. The computing device according to claim 12, wherein the preset virtual probe is controlled to be moved based on the safe surfaces.

15. The computing device according to claim 11, the storage medium according to claim 6, wherein the measurement element is created by:
fitting the measurement element based on the calculated coordinates of the measurement point and triangles adjacent to the measurement point according to a least-square method and a Quasi-Newton iterative method.
